(19) United States
(12) Patent Application Publication
(10) Pub. No.: US 2005/0067837 A1
(43) Pub. Date: Mar. 31, 2005

(54) Quick disconnect hose coupling

(75) Inventors: Gus Alexander, Inverness, IL (US); Morgan McCarthy, Schaumburg, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: FAIP North America, Inc, Elk Grove Village, IL (US)

(21) Appl. No.: 10/674,028

(22) Filed: Sep. 29, 2003

(51) Int. Cl. F16L 39/00

(52) U.S. Cl. 285/317

(57) ABSTRACT

A coupling for connecting flexible hoses together is provided. The coupling includes male and female fittings both of which include integral shank and quick disconnect coupling portions. The shank portions of the male and female fittings each being insertable at least partially in a respective one of the flexible hoses for securing the fittings to the hoses. The coupling portion of the male fitting including a stem and the coupling portion of the female fitting being configured to receive and non-threadably engage the stem of the male fitting. The coupling portion of the male fitting including a collar movable between locked and unlocked positions such that in the locked position the male and female fittings are securely engaged and in the unlocked position the stem portion of male fitting can be selectively decoupled from the coupling portion of the female fitting.

### FIELD OF THE INVENTION

The present invention relates generally to liquid hose couplings, and more particularly, to hose couplings which are adapted for quick connection and disconnection.

### BACKGROUND OF THE INVENTION

Anyone who has attempted to connect two lengths of hose by screwing together threaded fittings in the ends of the hoses can appreciate how awkward and difficult such connecting procedure can sometimes be. Not only can it be hard to screw the fittings sufficiently tightly by hand to prevent leakage, but over time, rust or contaminants that accumulate on the threaded fittings can prevent the fittings from being easily or completely threaded into engagement with each other.

To facilitate connection and disconnection of hose lengths together, it is known to use quick disconnect coupling adapters. Such adapters typically comprise a first adapter part that is connected to the male fitting of the hose and a second adapter part that is connected to the female fitting of one hose to be joined. One adapter part may comprise a female fitting which includes a plurality of radially displaceable balls and spring biased sleeve which can be longitudinally retracted to permit positioning of a male section of the other adapter part. Upon release of the spring biased sleeve, the sleeve retains the balls in a coupling or locking position. Manual retraction of the sleeve, permits disengagement of the adapter sections, and hence, quick disengagement of the hose lengths.

A problem with such quick disconnect coupling adapters is that they require time-consuming assembly on the existing hose fittings, and in use, create additional potential points of leakage. Specifically, the first adapter part must be screwed onto the existing fitting of one hose length and the second adapter part must be screwed onto the existing fitting of the second hose length. Upon engagement of the quick disconnect coupling adapter parts, in addition to the normal potential points of leakage between the existing hose fittings and the respective hoses, additional potential points of leakage exist at points of inter-engagement of each adapter part with its respective existing hose fitting, as well as between the interconnected adapter parts themselves.

### OBJECTS AND SUMMARY OF THE INVENTION

It is an object of the present invention to provide a quick disconnect hose coupling which is easier to use and which minimizes the chance of leakage between the connected hose lengths.

Another object is to provide a quick disconnect hose coupling as characterized above which eliminates time-consuming threaded connections between the adapter parts and existing hose fittings.

A further object is to provide a quick disconnect hose coupling of the above kind which has fewer potential leakage points between the connected hoses.

Still another object is to provide a quick disconnect hose coupling of the foregoing type which is relatively simple in construction and which lends itself to economical manufacture and reliable usage.

Other objects and advantages of the invention will become apparent upon reading the following detailed description and upon reference to the drawings, in which:

### BRIEF DESCRIPTION OF THE DRAWINGS

FIG. 1 is a perspective view of two illustrative lengths of hose equipped with a quick disconnect coupling according to the present invention.

FIG. 2 is a side sectional view of the quick disconnect coupling of FIG. 1 showing the how the ball retaining collar of the female fitting of the quick disconnect coupling can be retracted.

FIG. 3 is a side sectional view of the quick disconnect coupling of FIG. 1 showing the ball retaining collar of the female fitting in a locked position.

FIG. 4 is an end sectional view of the quick disconnect coupling of FIG. 1 taken along the plane of line 4-4 in FIG. 3.

FIG. 5 is a side sectional view of the male fitting of the quick disconnect coupling of FIG. 1.

FIG. 6 is a side sectional view of the female fitting of the quick disconnect coupling of FIG. 1.

FIG. 7 is an enlarged view of one of the ball receiving apertures of the female fitting of the quick disconnect coupling of FIG. 1.

While the invention is susceptible of various modifications and alternative constructions, a certain illustrated embodiment thereof has been shown in the drawings and will be described below in detail. It should be understood, however, that there is no intention to limit the invention to the specific form disclosed, but on the contrary, the intention is to cover all modifications, alternative constructions and equivalents falling within the spirit and scope of the invention.

### DETAILED DESCRIPTION OF PREFERRED EMBODIMENTS

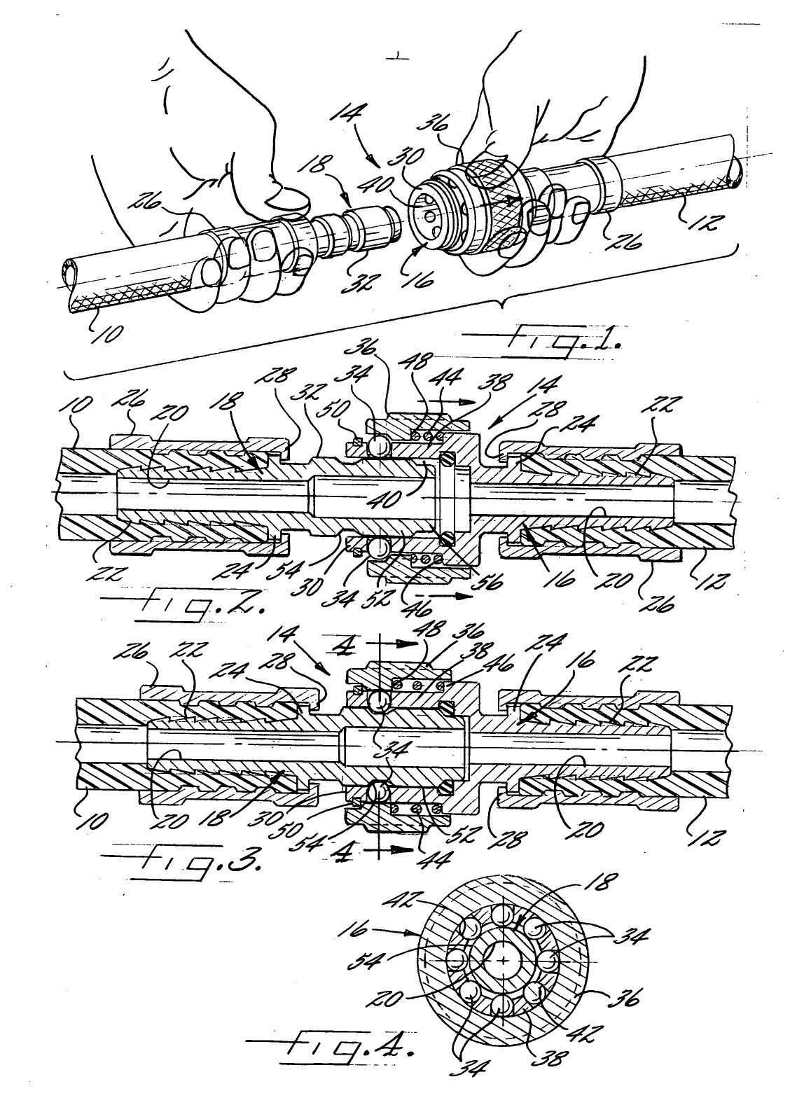

Referring now more particularly to the drawings, there is shown in FIG. 1 two illustrative lengths 10, 12 of hose having a quick disconnect coupling 14 in accordance with the invention. Each hose length 10, 12 in this case has a respective hose fitting 16, 18 at the ends of the hose to be connected (see FIGS. 2 and 3). Each of the fittings 16, 18, which preferably are made of metal, is formed with a liquid flow passageway 20 that communicates with the liquid flow passageway of the hose length 10, 12 to which it is connected. It will be understood that the opposite ends of the hose lengths 10, 12 also may be provided with appropriate fittings, either of a conventional type, or a quick disconnect type in accordance with the invention.

Each hose fitting 16, 18 in this case has a respective inwardly extending ribbed shank 22 that is forcefully positioned into the end of a hose length up to and against a radial locating flange 24 of the fitting as shown in FIGS. 2 and 3. An annular ferrule 26 is crimped about the end of the hose with an annular retaining flange 28 of the ferrule capturing the locating flange 24 of the fitting for positively securing the fitting to the hose.

In accordance with the invention, each of the fittings 16, 18 has a respective quick disconnect coupling portion 30, 32 that is integral with the ribbed shank 22 used to connect the hose fitting to the hose. These integral quick disconnect coupling portions 30, 32 are adapted for easy coupling and uncoupling with each other without threaded engagement. Specifically, in the illustrated embodiment, the hose fitting 16 has an outwardly-extending, integral cylindrical female coupling portion 30 that is adapted for nonthreaded, disengagable coupling with a corresponding outwardly-extending, integral male coupling portion 32 of the other hose fitting 18. For ease of reference herein, the hose fitting having the integral cylindrical female coupling portion 30 will be referred to as the female hose fitting 16 and the hose fitting with the integral male coupling portion 32 will be referred to as the male hose fitting 18.

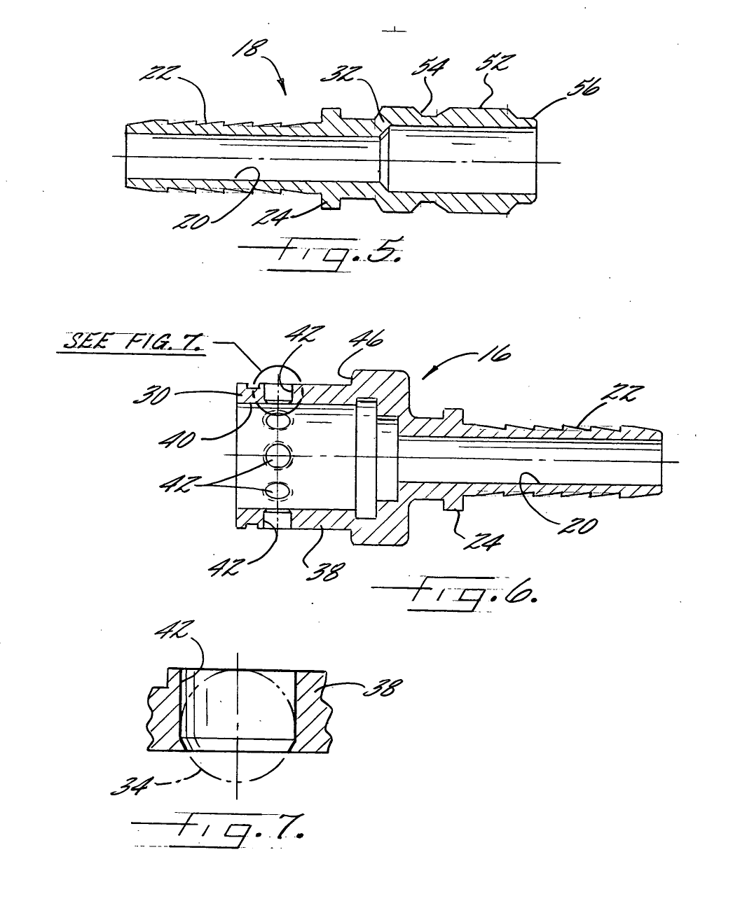

The coupling portion 30 of the female fitting 16 in this instance carries a plurality of radially displaceable locking balls 34 which are controlled by a spring biased longitudinally retractable ball retaining collar 36. The coupling portion 30 of the female fitting 16, as best depicted in FIG. 6, in this case includes a sleeve 38 that defines an inner cylindrical chamber 40. The sleeve 38 is formed with a plurality of circumferentially spaced ball receiving apertures 42 communicating through the sleeve adjacent the terminal end thereof. The apertures 42 preferably have an inwardly tapered conical configuration that supports the locking balls 34 when in a seated position, with portions thereof extending a predetermined radial distance into the cylindrical chamber 40 (see FIGS. 4 and 7).

For maintaining the locking balls 34 in a seated position in their respective apertures 42, the ball retaining collar 36 is positionable over the locking balls 34 under the force of a spiral biasing spring 44 interposed between an outwardly extending annular flange 46 of the female fitting 16 and inwardly turned annular lip 48 of the collar 36 (see FIG. 3). For eliminating outward longitudinal movement of the ball retaining collar 36 beyond the outer or terminal end of the female fitting 16, an annular clip 50 is supported in an outer annular groove of the sleeve 38. As will be understood by a person skilled in the art, when the ball retaining collar 36 is biased to its outermost position against the retaining clip 50, the collar 36 retains the locking balls 34 in their seated position protruding a predetermined distance into the cylindrical chamber 40 (see FIGS. 3 and 4). The ball retaining collar 36 is configured such that when the collar 36 is manually retracted against the force of the biasing spring 44 towards the annular flange 46, the collar permits limited outward radial movement of the locking balls 34 (see FIG. 2). Thus in the retracted or unlocked position, the ball retaining collar 36 allows the locking balls 34 to move to a position where they are outside of the cylindrical chamber 40, while still ensuring that the balls are retained in their respective apertures 42.

In keeping with the invention, the coupling portion 32 of the male fitting 18 is adapted for positioning within the coupling portion 30 of the female fitting 16 for quick engagement and disengagement by the locking balls 34. To this end, the coupling portion 32 of the male fitting 18 includes a generally cylindrical stem 52 that is configured so as to be positionable within the cylindrical chamber 40 of the coupling portion 30 of the female fitting 16 (see, e.g., FIGS. 2 and 3). The stem 52 is formed with an outer annular groove 54 for receiving the locking balls 34 when in they are in their seated position. As again will be understood by persons skilled in the art, the stem 52 of the coupling portion 32 of the male fitting 18 has a diameter less than the diameter of the cylindrical chamber 40 of the coupling portion 30 of the female fitting 16. However, the section of the stem 52 of the coupling portion 32 of the male fitting 18 immediately adjacent the groove 54 is greater than the internal diameter defined by the locking balls 34 when in their seated position. To facilitate outward radial movement of the locking balls 34 as an incident to positioning of the coupling portion 32 of the male fitting 18 within the coupling portion 30 of the female fitting 16, the leading edge of the stem 52 of the male fitting 18 is formed with a tapered camming section 56.

To quickly and easily couple the coupling parts 30, 32 together, the ball retaining collar 36 may be manually retracted from its locked position against the force of the spring 44 with one hand into a release position, while the stem 52 of the male fitting 18 is manually positioned into the cylindrical chamber 40 of the female fitting 16 (see FIG. 2). The forward tapered camming section 56 (see FIG. 5) of the stem 52 urges the locking balls 34 radially outwardly to permit positioning of the stem 52 of the male fitting 18 fully into position within the cylindrical chamber 40 of the female fitting 16. Once the stem 52 is properly positioned, the ball retaining collar 36 may be released. Once released, the ball retaining collar 36 automatically moves under the force of the spring 44 back into the locked position which urges the balls 34 into their seated and locked position within the groove 54 of the stem of the male fitting 18 (see FIG. 3). To quickly disconnect the hose fittings 1, 18, the ball retaining collar 36 again may be manually retracted against the force of the spring 44 into a release position to permit disengagement and separation of the coupling parts 30, 32.

From the foregoing, it can be seen, the quick disconnect hose coupling of the present invention can be quickly and easily connected to hose lengths without the need for any time-consuming threaded connections. Moreover, because the need for threaded connections is eliminated, the potential for leakage is also substantially reduced.

1. A coupling for connecting flexible hoses together comprising:
a male fitting including integral shank and quick disconnect coupling portions, the shank portion of the male fitting being insertable at least partially in one of the flexible hoses for securing the male fitting to the hose, the coupling portion of the male fitting including a stem; and
a female fitting including integral shank and quick disconnect coupling portions, the shank portion of the female fitting being insertable at least partially in one of the flexible hoses for securing the female fitting to the hose, the coupling portion of the female fitting being configured to receive and non-threadably engage the stem of the male fitting and including a collar movable between locked and unlocked positions such that in the locked position the male and female fittings are securely engaged and in the unlocked position the stem portion of male fitting can be selectively decoupled from the coupling portion of the female fitting.

2. The coupling according to claim 1 wherein the shank portions of the male and female fittings are ribbed.

3. The coupling according to claim 1 further including a pair of annular ferrules each being compressible over a section of flexible hose within which the shank portion of a respective one of the male and female fittings has been inserted.

4. The coupling according to claim 1 wherein the female fitting includes at least one locking element, the at least one locking element being movable between engaged and disengaged positions in response to movement of the collar between the locked and unlocked positions respectively.

5. The coupling according to claim 4 wherein the at least one locking element engages a groove in the stem of the male fitting.

6. The coupling according to claim 5 wherein the at least one locking element is one of a plurality of locking elements comprising locking balls.

7. The coupling according to claim 6 wherein the locking balls are retained on the coupling portion of the female fitting in both the engaged and disengaged positions by the collar.

8. The coupling according to claim 5 wherein movement of the stem of the male fitting relative to the causes the at least one locking element to move from the engaged to the disengaged position when the collar is in the unlocked position.

9. The coupling according to claim 1 wherein the female fitting further includes a spring that biases the collar towards the locked position.
